(19) United States
(12) Patent Application Publication
(10) Pub. No.: US 2004/0152049 A1
(43) Pub. Date: Aug. 5, 2004

(54) Dental restoration and method for fabrication thereof

(76) Inventor: Sebastiaan Cornelissen, Maarssen (NL)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/356,431

(22) Filed: Jan. 31, 2003

(51) Int. Cl. A61C 13/08

(52) U.S. Cl. 433/208

(57) ABSTRACT

A method of preparing a dental restoration that includes forming one or more galvano substructures; pressing the galvano substructures into a ceramic material to form a dental restoration; polishing an outer surface of the dental restoration; and sealing the dental restoration. The dental restoration may be a dental crown or a dental bridge. Dental restorations prepared using the method are also disclosed.

### BACKGROUND OF THE INVENTION

1. Field of the Invention

The present invention relates to a method for producing dental restorations and dental restorations produced by the method.

2. Description of Related Art

As people age, many find themselves with teeth that are no longer structurally sound. Root canals, lost fillings, decay below a filling, chipping, and cracking of the enamel may lead to large-scale defects in a tooth's surface. Additionally, grinding teeth, an improper bite, age, fillings, and tooth decay can all be contributing factors in the wearing down, cracking, or breakage of teeth. When the entire surface of the tooth is a problem, but the root system is intact, a dental crown is typically applied to the tooth to provide a proper tooth surface. Dental crowns cover the entire visible surface of an affected tooth and add strength, durability, and tooth stability.

A dental crown, also known as a cap, is a tooth-shaped covering that is placed over a tooth that has been badly decayed or damaged. Dental crowns are generally used when the damage or decay is so extensive that filling materials cannot make the tooth strong enough. In addition, crowns can be used to hold a bridge in place and to cover discolored or misshaped teeth. These crowns are anchored to the teeth on either side, with a bridge section connecting the two crowns. Instead of bridges, single tooth dental implants may be used that eliminate the need for supporting the crowns.

Bridges are one method to fill a gap created by a missing tooth (or teeth). A bridge is made up of two crowns for the teeth on either side of the gap and a false tooth in between. Natural teeth, dental implants, or a combination of natural teeth and dental implants can be used to support the bridge. There are three types of bridges. A traditional bridge consists of two crowns for the teeth on either side of the gap, with a false tooth in between. Traditional bridges are the most commonly used type of bridge and are typically made of ceramic or porcelain fused to metal. A cantilever bridge is used when there are teeth on only one side of the gap in the mouth. A Maryland bonded bridge is made up of plastic teeth and gums supported by a metal framework.

There are basically three types of crowns: those made of gold, ceramic crowns, and ceramic-veneered gold crowns. Gold and metal-ceramic crowns are extremely durable and are normally used in molars, where the forces from chewing and grinding are most prevalent. Ceramic crowns are used primarily for front teeth, since they can best resemble the natural tooth color.

Reinforced resin or bonded all-porcelain dental crowns typically provide an aesthetically pleasing appearance. This type of dental crown can be made from pure ceramic or a reinforced composite resin, and closely resembles a natural tooth. It is metal-free, and thus satisfies the needs of patients with metal sensitivities.

Gold crowns are appropriate when appearance is not a priority. The gold metal is extremely workable, making gold crowns a more precise fit. While there exists a slight possibility of chipping with porcelain crowns, gold crowns provide no such possibility.

Porcelain fused to metal crowns are often used to attempt to provide a natural appearance. However, they have a metal substructure and require an opaquer below the porcelain. This can make the translucency of natural teeth difficult to replicate. Occasionally, a dark line will be visible at the edge of the crown, near to the gum, as the crown recedes with age.

When applying a dental crown, a tooth is typically prepared by modifying it to the ideal shape for receiving the dental crown. This involves removing most of the outer surface, and leaving a strong inner core of the tooth. The amount of the tooth removed will be the same as the thickness of the dental crown to be fitted. Once the tooth is shaped, an impression is taken of the prepared tooth, one of the opposite jaw and possibly another to mark the way an individual's bite comes together. The impressions are used to make models of the mouth, and the dental crown is constructed to ensure that it fits properly.

Another type of crown, a post crown, is typically used when a tooth has been root filled. The weakened crown of the tooth is drilled off at the level of the gum. A double-ended ‘post’ to fit into the root canal is then made. The post may be prefabricated stainless steel or custom made of gold. One end of the post is cemented into the root canal, and the other end holds the dental crown in place.

Once the fit and appearance of the crown have been verified, it is cemented in place with dental cement. The cement also forms a seal to help hold the dental crown in place.

Over the years, however, the marketplace has seen various developments, which have placed additional demands upon the construction of dental crowns. The driving force for such developments has typically been to improve the aesthetics of the restorations. Alternate materials and new porcelains have been developed to be more life-like and modified alloys have been developed to accommodate the new porcelain.

The base metals used in the alloys sometimes produced a dark oxide, however, and it can be difficult to mask such oxides with the porcelain firings. The final restoration can, in such circumstances, be left with an unsightly dark line at the porcelain-metal junction.

Various attempts have been made to overcome the problems associated with the above-described conventional dental crown constructions. For example, U.S. Pat. No. 6,328,568 to Sato discloses a method for manufacturing a metallic dental crown that includes making a model base out of a base formed on a tooth root in an oral cavity; capping only a top portion of the model base with a mold material for forming a dental crown occlusal portion which is made of plastic film and which has a shallow royal crown configuration; coating that area of an outer peripheral surface of the model base, which is not capped with the mold material for forming the dental crown occlusal portion, with wax to form a composite mold material for forming the dental crown integral with the mold material for forming the dental crown occlusal portion; and substitution molding the composite mold material for forming the dental crown with a metal material.

U.S. Pat. No. Re. 33,271 to Shoher et al. discloses a dental jacket crown prepared from a thin metal foil substrate which is coated with a noble based metal composition having a low fusing temperature, and folded in a predetermined manner to form multiple folds in the form of triangular-like flaps or pleats. The folded foil represents a coping, which is mounted over a die of the prepared tooth, and the flaps wrapped in overlapping formation and then adapted to the die. The die is removed and the structure heated preferably under a Bunsen burner. A bonding material may be coated over the freestanding structure. A veneering material, such as porcelain, is then coated over the structure to form the crown.

U.S. Pat. No. 4,940,637 to Shoher et al. discloses a dental crown restoration, which includes a metal coping and a relatively thick outer coating of a ceramic dental veneer. The metal coping includes a lamination of a low-fusing temperature precious metal component that is composed substantially or entirely of gold and a high-fusing temperature precious metal component. The high-fusing temperature component is formed from three layers, with one layer composed of from 90 to 100% palladium bounded on both sides by a gold based layer.

U.S. Pat. No. 5,346,397 to Braiman discloses a process for making artificial porcelain teeth or laboratory fabricated dental crowns that includes casting or molding a plurality of tooth-shaped unfired shells from ceramic powder and a resin, acrylic, wax or starch in liquid form, and molding and hardening them into shapes of predetermined tooth contours. The dried powder-like, thin, and highly characterized outside shells of a general tooth shape are then merged into a full porcelain powder buildup of the tooth shape by using conventional porcelain powders mixed into a paste, typically as a filling medium, completing the buildup of tooth or crown form. The form is then placed into a furnace and heated to purge undesired resin, acrylic, wax or starch and other extraneous material, and then is baked conventionally to further purge and obtain an artificial tooth or crown in the most desirable form possible, which is then ground and polished.

U.S. Pat. No. 6,048,205 to Wright discloses a multilayer dental system for the production of restorations which incorporates a high strength bridging ceramic core, a layer of biocompatible metal for aesthetics and encasing the abutment, and a conventional porcelain top layer. The restoration is made by producing the high strength bridging ceramic core, electroforming 24 K gold upon the core, and then completing the restoration by applying outer layers of conventional dental porcelain. The completed units can be bonded or cemented within the patient's mouth, and are easily handled by the dentist.

The demand for standardized and automated manufacturing processes is one reason that electroforming methods for producing crowns, such as the AGC® technique commercialized by Wieland Dental and Technik GmbH & Co. KG, Pforzheim (Germany), has found widespread acceptance in the industry. Electroformed crowns, however, do not provide the aesthetic and functional performance found with all ceramic crowns.

There is, therefore, an established need for dental restorations, including crowns and bridges, which combine the advantages of all-ceramic systems with the reliability of metal-ceramic systems. Furthermore, there is a need for a system with which all types of dental restorations could be covered with a selection of ceramics.

### SUMMARY OF THE INVENTION

The present invention is directed to a method of preparing a dental restoration that includes forming one or more galvano substructures; pressing the ceramic material over the galvano substructures to form a dental restoration; polishing an outer surface of the dental restoration; and sealing the dental restoration.

The present invention is further directed to dental restorations prepared using the method described above.

### DETAILED DESCRIPTION OF THE INVENTION

Other than where otherwise indicated, all numbers or expressions referring to quantities or measurements used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations.

As used herein and in the claims, the terms “restoration” and “dental restoration” refer to dental restorative structures that include, but are not limited to, crowns, bridges, and false teeth.

As used herein and in the claims, the terms “crown” and “dental crown” refer to a tooth-shaped covering that is placed over a tooth.

As used herein and in the claims, the terms “bridge” and “dental bridge” refer to a dental restoration that includes one or more crowns and one or more false teeth used to fill a gap created by one or more missing teeth and includes, but is not limited to, three-unit bridge restorations in the anterior and posterior areas as well as longer-span bridges and inlay bridges.

As used herein and in the claims, the term “galvano substructure” refers to a metal crown formed by electroforming a thin metal layer on a substrate in the shape of a prepared tooth or post. In an embodiment of the present invention, the galvano substructure is formed by electroforming a gold core. The thin metal layer may be at least 10 μm, in some cases at least 25 μm, in other cases at least 50 μm and in some situations at least 100 μm thick and may be up to 500 μm, in some cases up to 400 μm, in other cases up to 300 μm and in some situations up to 200 μm thick. The thickness of the metal layer may vary between any of the values recited above. The galvano substructure may include one or more metals selected from Au, Ag, Ir, Cu, Zn, Al, Pt, In, Sn, Pd, Bt, Y, Ti, mixtures thereof and alloys thereof. In a further embodiment, the galvano substructure includes at least 50 wt. % Au. In a particular embodiment of the present invention, the galvano substructure is at least 90 wt. % Au, typically at least 99.9 wt. % Au.

The present invention is generally directed to a method of making dental restorations that includes overlaying a galvano substructure with a ceramic crown. The dental restorations of the present invention include, but are not limited to, individual crowns and three-unit bridge restorations in the anterior and posterior areas as well as longer-span bridges and inlay bridges. Dental restorations made using the present method typically require 4-6 fewer ceramic firings and typically save 45 minutes per crown.

Thus, the present method of preparing a dental restoration includes the steps of forming one or more galvano substructures, pressing the ceramic material over the galvano substructures to form a dental restoration, polishing an outer surface of the dental restoration, and sealing the dental restoration.

The method of the present invention generally includes a groove or circular margin step preparation. The present invention combines the advantages of electroforming methods for producing crowns, a non-limiting example of which is the AGC® technique commercialized by Wieland Dental and Technik GmbH & Co. KG, Pforzheim (Germany) and ceramic crowns, a non-limiting example of which is the Authentic® pressed ceramic system available from Microstar, Atlanta, Ga. In the present method, it is possible to overlay crown and bridge substructures with pressed ceramic systems and also to produce extremely stable and accurately fitted circular ceramic margins. The dental restorations provided by the present method have an excellent ceramic-to-metal bond and an extraordinarily accurate and stable circular porcelain margin.

In the present method, a conventional galvano substructure is produced, which may be manufactured easily because the edge of the crown can be omitted. The edge of the crown is worked by a circular margin using a pressed ceramic system. The galvano substructure reduced as described above is removed from a peg and is sandblasted with aluminum oxide. The aluminum oxide forms a layer that is at least 10 μm, in some cases at least 20 μm, in other cases at least 30 μm and in some situations at least 50 μm thick and may be up to 300 μm, in some cases up to 200 μm, in other cases up to 150 μm and in some situations up to 110 μm thick. The thickness of the aluminum oxide layer may vary between any of the values recited above.

Typically, the galvano substructure of the present invention is formed by (a) providing an electrolyte solution in a retainer, a first electrode member having means for supporting a substrate, a substrate supported thereby, a second electrode member comprising a metal basket for containing in electrical connection therewith a piece of metal to be electrodeposited, connecting means for mounting the first electrode member in the retainer and intended for connecting the first electrode member to one pole of a direct current supply, and a mounting means for mounting the second electrode member in the retainer; (b) supporting a substrate on the first electrode member within the electrolyte; (c) connecting the piece of metal in the basket of the second electrode member to one pole of a direct current supply; (d) connecting the substrate on the first electrode to the other pole of the direct current supply; and (e) passing an electric current through the electrolyte.

The galvano substructure of the present invention may be electroformed using any suitable devices for electrodeposition. Such suitable devices include, but are not limited to, the AGC® Micro, the AGC® Micro Plus, and the AGC® Speed available from Wieland Dental and Technik.

Optionally, an opaquer may be used to shade the galvano substructure. After the opaquer has been fired, the crown is placed on the previously isolated peg and the circular margin including the dentin structure is modeled. At this point, the natural appearance of the tooth is matched as much as possible. Optionally, a full wax-up can also be created to achieve a controlled reduction of the melt. The modeling done in the manner described above is then prepared for the pressing process. The wax-up is tacked perpendicular to the tip of the galvano substructure. Wax profiles, typically 3.0 mm thick, are used.

A sprue layout is carefully designed, because if the sprue is tacked at an angle, there is a danger that the galvano substructure will be lifted in the pressing compound and can thus be under-pressed. The item to be pressed is placed in the pressing furnace according to the manufacturer's instructions. Any suitable pressing furnace may be used in the present invention, a non-limiting example of which is the Authentic® Ceramay available from Microstar. The investment and pre-heating are the same as in a conventional pressing process.

Press pellets may be used in the present method. For example, one or more ceramic press pellets having 40% to 70% opaqueness or any other glass ceramics with 40% to 70% opaqueness may be used to obtain different opacity levels. As a non-limiting example, Authentic® Press Pellets (Microstar) may be used. Therefore, the selection and use of the pellets is particularly important.

Unlike conventional methods for preparing dental restorations, the present method does not require a baking or burning step, which can lead to distortion of the restoration and a poor fit. In the present method a pressing step is used instead of a conventional baking or burning step.

Typically in the present method, the ceramic material is pressed over the galvano substructures by pressing ceramic material onto an outer surface of the galvano substructure to form a dental restoration, sintering the ceramic dental restoration, and processing the dental restoration to a desired shape. In an embodiment of the present invention, the ceramic material is in a dry form.

Because the ceramic is pressed directly onto the galvano substructure, the margin is non-shrinking and stable, which is a particular benefit arising from the present method. The present method also achieves a perfect edge connection all the way around. Dental restorations made using the present method have the highest aesthetic quality.

After the pressing process, the dental restorations are carefully removed. The coarse fragments of the investment material are removed by blasting with glass pearls at from 1 to 5 bar, typically 1.5 bar. The inner side of the overlaid galvano substructure is cleaned at a lower pressure (maximum 1.0 bar). The units cleaned as described above automatically have a correct fit on account of the overlaid galvano parts.

The separation of the units from the sprue is typically done at low speed and under water. Overheating at any point may lead to the formation of micro-cracks in the ceramic, which become visible during the subsequent firing operations. After the units have been seated, minor shape corrections are performed. Care must be taken that there is sufficient space available for the application of fusible sealants and finishes. Finally, the entire pressed ceramic system is lightly polished with a diamond wheel and cleaned using high-pressure steam.

Customized shades may be applied to the ceramic crown prepared as described above using suitable stains and stabilized by a fixing firing. Because the ceramic structure is a solid substrate, it is only necessary to apply a small amount of fusible sealant. This operation achieves a controlled shrinkage. Thus, a particular benefit of the present invention is a non-shrinking, stable margin in the ceramic shade. It is thereby possible to control the function of the ceramic compounds. In the posterior area, abrasive compounds are used typically on the exterior and as an edge strip. The occlusal surface itself is realized with warm transparent compounds, for example, orange or yellow. The light that falls on the occlusal surface is, therefore, not reflected, but absorbed, which gives the impression of depth. In the anterior portion, a fusible sealant is applied medially and distally to the edge strips, resulting in the reflection strips being accentuated.

The completion of the exterior of the ceramic crown may include coatings of transparent and half-half fusible coatings, which may be applied in an alternating fashion. The subsequent firing is typically done at a temperature at least 200° C. below the pressing temperature of 940° C., but may be done at a temperature up to 760° C. This guarantees that the ceramic margin remains absolutely stable and retains its shape, providing a precise fit. For bridge constructions, no correcting firing is necessary, because the basal portions or interdental and occlusal contacts are present as a result of the ceramic fit.

Because the present method is straightforward, it can be easily used to prepare bridge constructions with a circular margin. An additional advantage of the pressed margin is a complete seat, not only in the outer area, but also in the entire area of the margin.

Diamond wheels are used to polish the crowns into their final shape. The surface structure is applied and the occlusal contacts are adjusted.

It is important that the pressed ceramic that is in contact with the surface is sealed with an appropriate glazing compound. As a non-limiting example, the Authentic® glazing and stains (available from Microstar) may be used. A natural surface effect may be achieved by mechanical polishing using glass beads or diamond paste.

An advantage of dental restorations made using the present method is that they may be inserted both conventionally and, in extremely small metal structures, by using adhesive. Additionally, the present dental restorations may be prepared in a fraction of the time required for preparing conventional dental restorations.

The present invention is also directed to dental restorations prepared using the method described above. Such dental restorations include, but are not limited to, dental crowns and dental bridges. As such, the dental restorations according to the present invention include a galvano substructure having an inner surface and an outer surface; and a ceramic crown disposed on the outer surface of the galvano substructure. The galvano substructure is bonded to the ceramic crown.

In an embodiment of the present invention, the ceramic crown is a press crown. The press crown may include one or more materials selected from leucite crystals, fluorapatite leucite crystals, hydroxyapatite crystals, sodalime glass, feldspathic ceramics, alumina ceramics, glass ceramics, mica crystals, zirconia ceramics, SiO₂, Na₂O, CaO, ZrO₂, K₂O, ZnO, and Al₂O₃.

In an embodiment of the present invention, the galvano substructure may include one or more metals selected from Au, Ag, Ir, Cu, Zn, Al, Pt, In, Sn, Pd, Bt, Y, Ti, mixtures thereof, and alloys thereof. In a further embodiment, the galvano substructure includes at least 50 wt. % Au. In a particular embodiment of the present invention, the galvano substructure is at least 99.9 wt. % Au.

In an embodiment of the present invention, the galvano substructure is bonded to the ceramic crown by applying a bonding agent to the outer surface of the ceramic crown such that the bonding agent forms a film between the outer surface of the galvano substructure and an inner surface of the ceramic crown.

In a further embodiment of the present invention, a sealing material is disposed over an outer surface of the ceramic crown.

In an additional embodiment of the present invention, a dental crown is attached to a base. The base may be one or more of a formed tooth fragment, a metal post, and a bridge. The dental crown may be attached to the base using one or more suitable cements. Suitable cements include, but are not limited to, zinc phosphate cements, polymerizable cements, and curable cements.

The dental restorations of the present invention made using the method described herein have margins that fit exactly, which has not been heretofore achievable in the art due to the repeated burning and subsequent shrinkage that takes place using conventional methods. Additionally, the inventive dental restorations provide a more aesthetically pleasing and natural appearance due to the color of the gold that shines through the ceramic.

Further, the present dental restorations are longer lasting than prior art restorations because the galvano substructure supports the ceramic not only at its edge, but over its entire surface.

The present invention has been described with reference to specific details of particular embodiments thereof. It is not intended that such details be regarded as limitations upon the scope of the invention except insofar as and to the extent that they are included in the accompanying claims.

I claim:

1. A method of preparing a dental restoration comprising:
forming one or more galvano substructures;
pressing the ceramic material over the galvano substructures to form a dental restoration;
polishing an outer surface of the dental restoration; and
sealing the dental restoration.

2. The method of claim 1, wherein the galvano substructure is formed by:
providing an electrolyte solution in a retainer, a first electrode member having means for supporting a substrate, a substrate supported thereby, a second electrode member comprising a metal basket for containing in electrical connection therewith a piece of metal to be electrodeposited, connecting means for mounting the first electrode member in the retainer and intended for connecting the first electrode member to one pole of a direct current supply, and a mounting means for mounting the second electrode member in the retainer;
supporting a substrate on the first electrode member within the electrolyte;
connecting the piece of metal in the basket of the second electrode member to one pole of a direct current supply;
connecting the substrate on the first electrode to the other pole of the direct current supply; and
passing an electric current through the electrolyte.

3. The method of claim 1, wherein the ceramic material is pressed over the galvano substructures by:
pressing ceramic material onto an outer surface of the galvano substructure to form a dental restoration;
sintering the ceramic dental restoration; and
processing the dental restoration to a desired shape.

4. The method of claim 3, wherein the ceramic material is one or more ceramic press pellets having 40% to 70% opaqueness.

5. The method of claim 1, wherein after the pressing step, a stain is applied to the dental restoration.

6. The method of claim 1, wherein the dental restoration is a dental crown.

7. The method of claim 1, wherein the dental restoration is a dental bridge.

8. The method of claim 1, wherein a glazing compound is applied as part of the sealing step.

9. A dental restoration prepared according to the method of claim 1.

10. A dental crown prepared according to the method of claim 1.

11. A dental bridge prepared according to the method of claim 1.

12. A dental restoration comprising:
a galvano substructure comprising an inner surface and an outer surface; and
a ceramic crown disposed on the outer surface of the galvano substructure;
wherein the galvano substructure is bonded to the ceramic crown.

13. The dental restoration of claim 12, wherein the ceramic crown is a press crown.

14. The dental restoration of claim 13, wherein the press crown comprises one or more materials selected from the group consisting of leucite crystals, fluorapatite leucite crystals, hydroxyapatite crystals, sodalime glass, feldspathic ceramics, alumina ceramics, glass ceramics, mica crystals, zirconia ceramics, SiO₂, Na₂O, CaO, ZrO₂, K₂O, ZnO and Al₂O₃.

15. The dental restoration of claim 12, wherein the galvano substructure comprises one or more metals selected from the group consisting of Au, Ag, Ir, Cu, Zn, Al, Pt, In, Sn, Pd, Bt, Y, Ti, mixtures thereof and alloys thereof.

16. The dental restoration of claim 12, wherein the galvano substructure comprises at least 50 wt. % Au.

17. The dental restoration of claim 12, wherein the galvano substructure is bonded to the ceramic crown by applying a bonding agent to the outer surface of the ceramic crown, such that the bonding agent forms a film between the outer surface of the galvano substructure and an inner surface of the ceramic crown.

18. The dental restoration of claim 12, wherein a sealing material is disposed over an outer surface of the ceramic crown.

19. The dental restoration of claim 12 attached to a base.

20. The dental restoration of claim 19, wherein the base is selected from a group consisting of formed tooth fragment, a metal post, and a bridge.

21. The dental restoration of claim 19, wherein the dental crown is attached to the base using one or more cements selected from zinc phosphate cements, polymerizable cements, and curable cements.

22. The dental restoration of claim 12, wherein the dental restoration is a dental crown.

23. The dental restoration of claim 1, wherein the dental restoration is a dental bridge.
